(19) United States
(12) Patent Application Publication
(10) Pub. No.: US 2026/0079843 A1
(43) Pub. Date: Mar. 19, 2026

(54) SOFT ERROR PROTECTION FOR UNHARDENED PROCESSORS

(71) Applicants: THE REGENTS OF THE UNIVERSITY OF COLORADO, A BODY CORPORATE, Denver, CO (US); National Technology & Engineering Solutions of Sandia, LLC, Albuquerque, NM (US)

(72) Inventors: Christopher George Hodgkins, Broomfield, CO (US); Josh Joffrion, Albuquerque, NM (US); Benjamin Feinberg, Albuquerque, NM (US); Sapan Agarwal, Needham, MA (US); Zachary McKevitt, Broomfield, CO (US); Joseph Izraelevitz, Boulder, CO (US); Henri Malahieude, Boulder, CO (US)

(21) Appl. No.: 19/327,771

(22) Filed: Sep. 12, 2025

Related U.S. Application Data
(60) Provisional application No. 63/694,702, filed on Sep. 13, 2024.

(51) Int. Cl. G06F 12/0831; G06F 11/07; G06F 11/14; G06F 12/02; G06F 12/0808; G06F 12/0864; G06F 12/0875

(52) U.S. Cl. CPC G06F 12/0835; G06F 11/0757; G06F 11/1407; G06F 12/023; G06F 12/0808; G06F 12/0864; G06F 12/0875

(57) ABSTRACT

A Single Event Upset Protector (SEUP) solution receives assembly code corresponding to a program and generates a primary thread and a shadow thread, each operating in different address spaces of an unhardened processor. The SEUP solution inserts swizzling operations in the shadow thread to maintain canonical pointer values and inserts turnouts in both threads to look for checkpoints. A SEUP solution insert a SEUP (e.g., hardware) between the unhardened processor and (a) a data memory and (b) a peripheral bus. The SEUP caches memory writes to the data memory and I/O writes to the peripheral bus. The SEUP restarts the primary thread and the shadow thread at a previous checkpoint when a watchdog indicates a hang and when the cached memory writes and the cached I/O writes by the primary thread to not match the cached memory writes and the cached I/O writes by the shadow thread.

### RELATED APPLICATIONS

This application claims priority to U.S. Patent Application Ser. No. 63/694,702, titled “Soft Error Protection for Unhardened Processors”, filed Sep. 13, 2024, and incorporated herein in its entirety by reference.

### GOVERNMENT RIGHTS

This invention was made with Government support under Contract No. DE-NA0003525 awarded by the United States Department of Energy/National Nuclear Security Administration. This invention was made with Government support under grant number 1563605 awarded by the Sandia National Laboratory. The Government has certain rights in the invention.

### FIELD

The present invention relates to fault-tolerant computing systems, and more specifically to protecting unhardened processors from soft errors caused by radiation-induced single event upsets.

### BACKGROUND

Radiation including photons or charged particles having sufficient energy can be absorbed in semiconductor junctions causing release of carriers (electrons and holes) within those junctions; when these carriers are formed at junctions within a processor these carriers may then cause a register or memory bit to be misread or other error to occur. Such a random error may have consequences for an executing program ranging from a minor change in a value, to major such as causing a random jump in program flow—depending on what register or bit was misread and when that happened in program execution. This is one potential cause of “soft”, or random and nonrepeatable, errors in program execution that occurs with higher frequency in high-radiation environments than in low-radiation environments.

Some “rad-hard” IC processes, such as silicon-on-insulator technologies, and design techniques can reduce soft error rates, but these processes and design techniques are rarely used for the latest, state-of-the-art, high-performance, processors. While some rad-hard processors are available, they are frequently much more expensive, lower performance, and of much older processor architectures than state-of-the-art high-performance processors.

Processor use in high-radiation environments is increasing with artificial intelligence and other modern software placing high loads on those processors. Processors intended for high-radiation environments may include processors of spacecraft and processors of robotic devices used in high-radiation environments of nuclear power plants and nuclear material processing plants as well as systems intended for continued operation after nuclear attack.

### SUMMARY

One aspect of the present embodiments includes the realization that performance and design of a most recently available radiation-hardened (rad-hard) processor is significantly slower and older than performance and design of a most recent unhardened processor (e.g., a commodity-off-the-shelf (COTS) processor), and thus available processing performance for use in a high-radiation environment is reduced. The present embodiments solve this problem by providing a Single Event Upset Protector (SEUP) solution that provides single event upset (SEU) protection for an unhardened processor used within the high-radiation environment. Advantageously, the SEUP solution allows a computing platform in a high-radiation environment to use a unhardened processor to take advantage of the faster performance.

In certain embodiments, the techniques described herein relate to a method for soft error protection of an unhardened processor, including: receiving assembly code corresponding to a program; generating a primary thread and a shadow thread, each operating in different address spaces of the unhardened processor; inserting swizzling operations in the shadow thread to maintain canonical pointer values; and inserting a Single Event Upset Protector (SEUP) between the unhardened processor and (a) a data memory and (b) a peripheral bus, the SEUP caching, for both the primary thread and the shadow thread, memory writes to the data memory and I/O writes to the peripheral bus; wherein the SEUP restarts the primary thread and the shadow thread at a previous checkpoint when the thus cached memory writes and the thus cached I/O writes by the primary thread do not match the cached memory writes and the cached I/O writes by the shadow thread.

In certain embodiments, the techniques described herein relate to a system for protecting an unhardened processor from soft errors, including: a Single Event Upset Protector (SEUP) transform tool, implemented as software with machine-readable instructions executable by a processor, for causing the processor to transform a program into a primary thread and a shadow thread that operate in different address spaces and run concurrently on different cores of the unhardened processor; a SEUP positioned between the unhardened processor and (a) a data memory and (b) a peripheral bus, the SEUP having: a control unit; an upstream bus controller for interfacing with the unhardened processor; a downstream bus controller for interfacing with the data memory; and a log for caching memory writes to the data memory for both the primary thread and the shadow thread; and an Overflow/Input/Output (OIO) queue for caching I/O writes to the peripheral bus for both the primary thread and the shadow thread; wherein, at an end of a checkpoint period, the control unit is adapted to trigger a rollback of the unhardened processor when the thus cached memory writes in the log and the thus cached I/O writes in the OIO queue for the primary thread do not match the thus cached memory writes in the log and the thus cached I/O writes in the OIO queue for the shadow thread.

### BRIEF DESCRIPTION OF THE FIGURES

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram illustrating one example satellite with a computing platform using an unhardened processor with soft error protection, in embodiments.

FIGS. 2A, 2B, and 2C show example operation of the SEUP of FIG. 1, in embodiments.

FIG. 3 is a block diagram one example SEUP solution that includes a software portion and a hardware portion implementing a SEUP that represents the SEUP of FIG. 1, in embodiments.

FIG. 4 is a block diagram illustrating one example address map generated for the SEUP solution of FIG. 3 by the SEUP transform tool when unhardened processor is a RISCV64 processor, in embodiments.

FIG. 5 shows one example turnout placement algorithm for placing turnout code within the primary code and the shadow code of FIG. 3, in embodiments.

FIG. 6 is a block diagram illustrating one example StoreVector used by the turnout placement algorithm of FIG. 5, in embodiments.

FIG. 7 is a schematic illustrating one example hardware design of the SEUP of FIG. 3, in embodiments.

FIG. 8 is a flowchart illustrating one example method for implementing the SEUP solution of FIG. 3, in embodiment.

FIG. 9 is a flowchart illustrating one example method for soft error protection for unhardened processors, in embodiments.

### DETAILED DESCRIPTION OF THE EMBODIMENTS

In the following description, certain specific details are set forth in order to provide a thorough understanding of various disclosed embodiments. However, one skilled in the relevant art will recognize that embodiments may be practiced without one or more of these specific details, or with other methods, components, materials, etc.

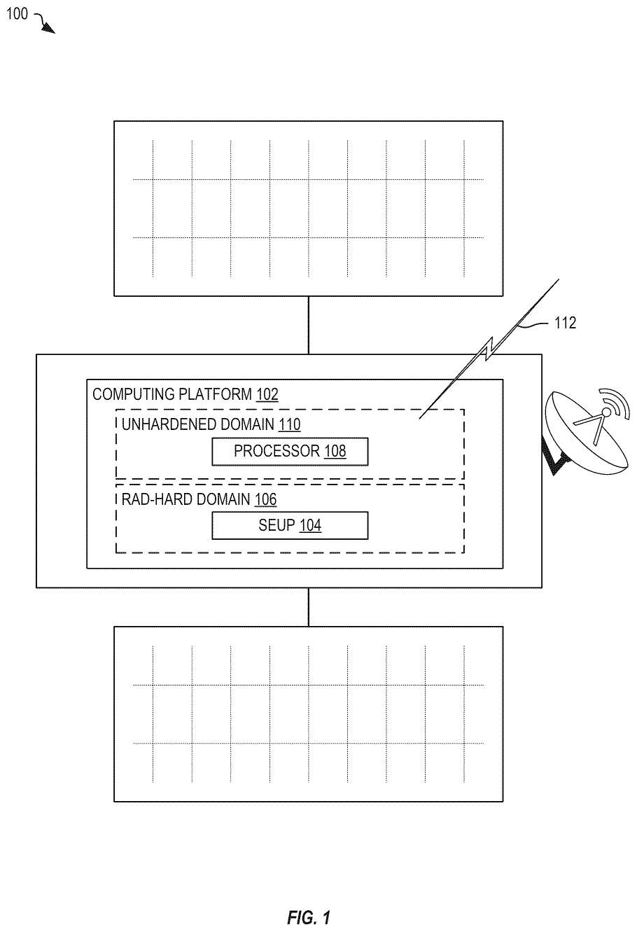

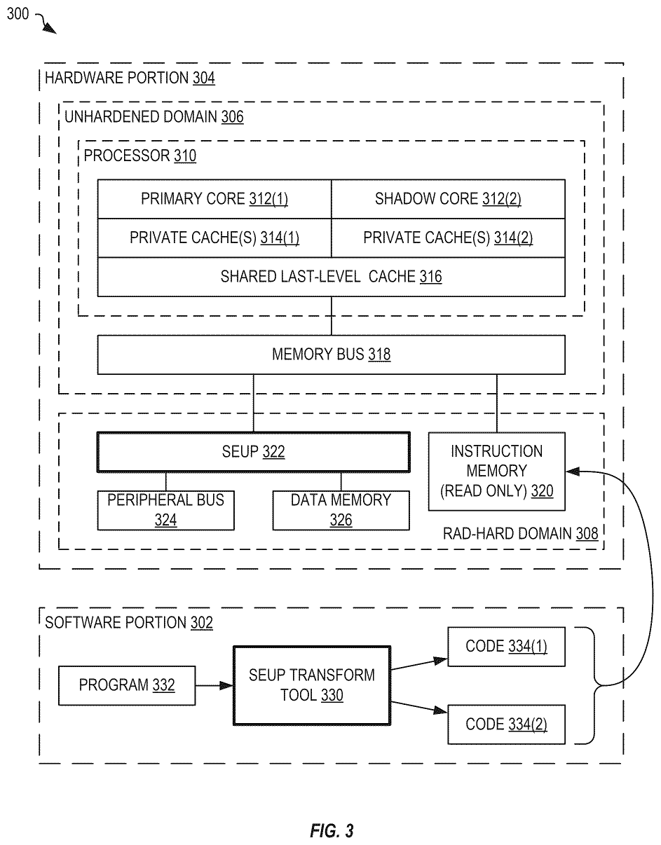

FIG. 1 is a schematic diagram illustrating one example satellite 100 with a computing platform 102 using an unhardened processor 108 with soft error protection, in embodiments. The soft error protection is implemented by a single event upset protector (SEUP) 104 in a rad-hard domain 106. SEUP 104 is part of a SEUP solution (see SEUP solution 300 of FIG. 3) that allows operation of unhardened processor 108 within unhardened domain 110 (e.g., a high-radiation environment) where SEUP 104 monitors and corrects for non-destructive single event upsets (SEUs) in unhardened processor 108 caused by high-level radiation 112, thereby allowing unhardened processor 108 to withstand worst space weather of a geosynchronous orbit during extreme solar events for example.

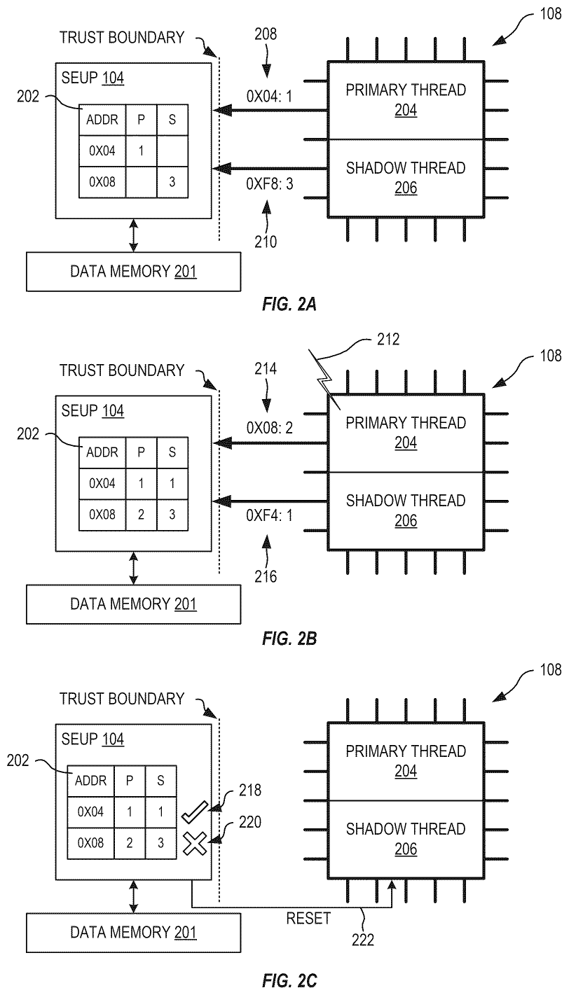

FIGS. 2A, 2B, and 2C are block diagrams illustrating three example high-level steps, respectively, illustrating operation of SEUP 104 of FIG. 1 implementing soft protection of unhardened processor 108, in embodiments. SEUP 104 is positioned between unhardened processor 108 and data memory 201. Unhardened processor 108 includes two cores that run two redundant threads, a primary thread 204 and a shadow thread 206 that operate in different address spaces of data memory 201 based on an address offset (e.g., an offset of 16 in this example). Operation of primary thread 204 and shadow thread 206 includes checkpoints, where the period between two checkpoints is called an epoch/

SEUP 104 maintains a log 202 that stores writes 208 and 214 from primary thread 204 to data memory 201 and writes 210 and 216 from shadow thread 206 to data memory 201.

However, SEUP 104 implements the writes to data memory 201 only when both primary thread 204 and shadow thread 206 provide the same data values and corresponding addresses at the end of an epoch. FIG. 2A shows write 208 having a data value of 1 going to address 0x04 from primary thread 204, and write 210 having a data value of 3 going to address 0XF8 from shadow thread 206. SEUP 104 updates log 202 accordingly, taking into account the address offset between primary thread 204 and shadow thread 206. FIG. 2B shows primary thread 204 being affected by a radiation event 212 and write 214 having a data value of 2 going to address 0x08 from primary thread 204, and write 216 having a data value of 1 going to address 0XF4 from shadow thread 206. SEUP 104 updates log 202 accordingly, taking into account the address offset between primary thread 204 and shadow thread 206.

FIG. 2C shows SEUP 104 evaluating log 202 at the end of an epoch, determining that primary thread 204 and shadow thread 206 agree (indicated as check 218) on address 0x04, but disagree (indicated as cross 220) on address 0x08. Accordingly, no data is written to data memory 201 and SEUP 104 sends a reset 222 to unhardened processor 108, causing primary thread 204 and shadow thread 206 to rollback to a previous checkpoint to repeat the processing of the unsuccessful epoch.

FIG. 3 is a block diagram one example SEUP solution 300 that includes a software portion 302 and a hardware portion 304 implementing a SEUP 322 that represents SEUP 104 of FIG. 1, in embodiments. Hardware portion 304 may represent at least part of computing platform 102 of FIG. 1, where software portion 302, implemented by a computer with memory and at least one processor, configures hardware portion 304 to implement a program 332. For example, program 332 is defines to provides a computing solution for computing platform 102 of satellite 100.

Hardware portion 304 is formed with an unhardened domain 306 (e.g., unhardened domain 110) and a rad-hard domain 308 (e.g., rad-hard domain 106). Unhardened domain 306 includes an unhardened processor 310 that may represent unhardened processor 108. Unhardened processor 310 includes at least two processing cores 312 (e.g., a primary core 312(1) and a shadow core 312(2)), each having a private cache 314(1) and 314(2), respectively, and a shared last-level cache 316. Unhardened processor 310 communicatively couples with a memory bus 318 that may also be within unhardened domain 306.

Rad-hard domain 308 is a radiation hardened portion of hardware portion 304 and includes an instruction memory 320 communicatively coupled with memory bus 318 and SEUP 322 also communicatively coupled to memory bus 318. SEUP 322 is positioned between memory bus 318 and each of a peripheral bus 324 and a data memory 326 (e.g., magnetoresistive random-access memory (MRAM)) that are also within rad-hard domain 308. Accordingly, unhardened processor 310 accesses peripheral bus 324 and data memory 326 via SEUP 322.

Software portion 302 includes a SEUP transform tool 330 that processes program 332 to generate codes 334(1) and 334(2) to run on cores 312(1) and 312(2), respectively. SEUP transform tool 330 is software with machine-readable instructions that are executed by a processor (e.g., a server or other computing system) to perform functionality of SEUP transform tool 330 as described herein. Code 334(1) and code 334(2) are slightly different, as will become apparent below, but effectively cause unhardened processor 310 to run redundant versions of program 332, each as a single thread running on a different core 312 and in a separate address spaces to provide spatial redundancy. A main difference between code 334(1) and code 334(2) is the address space being used by each core 312. Since each cores 312 are spatially separated on unhardened processor 310, and codes 334 use spatially separated portions of data memory 326 that are effectively in different areas of data memory 326, a single SEU can only affect one core 312.

SEUP 322 monitors memory and I/O traffic of both cores 312 (e.g., of each thread) to detect divergent behavior that is indicative of an SEU. Since both cores 312 each effectively run program 332, their memory and I/O traffic should be substantially the same, differing only in the offset address spaces used. When SEUP 322 detects a mismatch in memory or I/O traffic (other than the address space offset), SEUP 322 causes a checkpoint-based rollback of unhardened processor 310. A checkpoint-based rollback resets processor 310 to conditions at a previous checkpoint.

SEUP 322 is designed to avoid several limitations and inefficiencies common in prior art. SEUP solution 300 protects caches 314 and 316, unlike most prior solutions that either disable the caches or simply assume they are not vulnerable to errors due to use of error correction codes. With SEUP solution 300, cores 312 running program 332 may freely satisfy reads from caches 314 and 316. Writes to caches 314 and 316 are flushed to data memory 326 before a checkpoint, and data remains in the caches to serve future reads, even across checkpoints. Accordingly, disruption by SEUP solution 300 to running of program 332 is minimal without SEUs, allowing computing platform 102 to take full advantage of the processing power of unhardened processor 310.

SEUP solution 300 eliminates coherence conflicts. Most prior art redundant multithreading approaches use the same data working set for both threads, leading to frequent coherence conflicts between private caches 314. SEUP transform tool 330 generates codes 334 to use different address spaces and therefore cores 312(1) and 312(2) use entirely disjoint address spaces from the perspective of processor 310, eliminating coherence conflicts (albeit at the cost of halving the available shared cache space). SEUP solution 300 supports externally synchronous I/O writes, meaning that I/O writes are performed once and are never rolled back, even in the presence of errors. That is, SEUP 322 writes data to data memory 326 at the end of an epoch (e.g., a period between checkpoints defined below) when no SEU was detected. SEUP solution 300 supports a bare-metal deployment where program 332 runs without an operating system or virtual memory, as is common for embedded systems. SEUP solution 300 is designed to allow fast recovery, since recovery consists only of reloading the register set from SEUP 322 and clearing the caches. This avoids the penalty that comes from reverting significant amounts of system state as done by the prior art.

### Seup Binary Transform

SEUP transform tool 330 performs an assembly-to-assembly transform that includes three primary tasks: (1) duplicate program 332 to form primary and shadow threads through a custom address space layout and use of pointer swizzling, (2) insert clean instructions to flush dirty cache lines to SEUP 322, and (3) insert turnouts. A turnout is a small block of code that is inserted by SEUP transform tool 330 into codes 334 to check for a checkpoint. SEUP transform tool 330 performs SEUP transformation at the assembly level because and uses knowledge of register allocation: accesses to memory are swizzled and count towards turnout placement, while register accesses have no special handling.

In one example of operation, source code is compiled into assembly language using a standard compiler (e.g., gcc) to form program 332. The compiler is configured to reserve two registers for use by SEUP 322; a SEUP offset register for storing a SEUP offset and a checkpoint register for storing checkpoint signals. SEUP transform tool 330 then transforms program 332 into codes 334(1) and 334(2) that are each SEUP-compatible assembly language.

Codes 334(1) and 334(2) are then assembled and linked into a custom executable and linkable format (ELF) that includes various segments (e.g., memory of code 334 when running on core 312) that are specific to operation with SEUP 322. The ELF data is loaded by a SEUP bootloader on a bare-metal (e.g., no operating system (OS)) computing platform (e.g., computing platform 102). Where C standard library functionality (e.g. malloc, etc.) is required, a modified version of the library (e.g., musl libc—a popular standard library that is designed specifically for static linking and embedded systems) is statically linked.

### Redundant Addressing

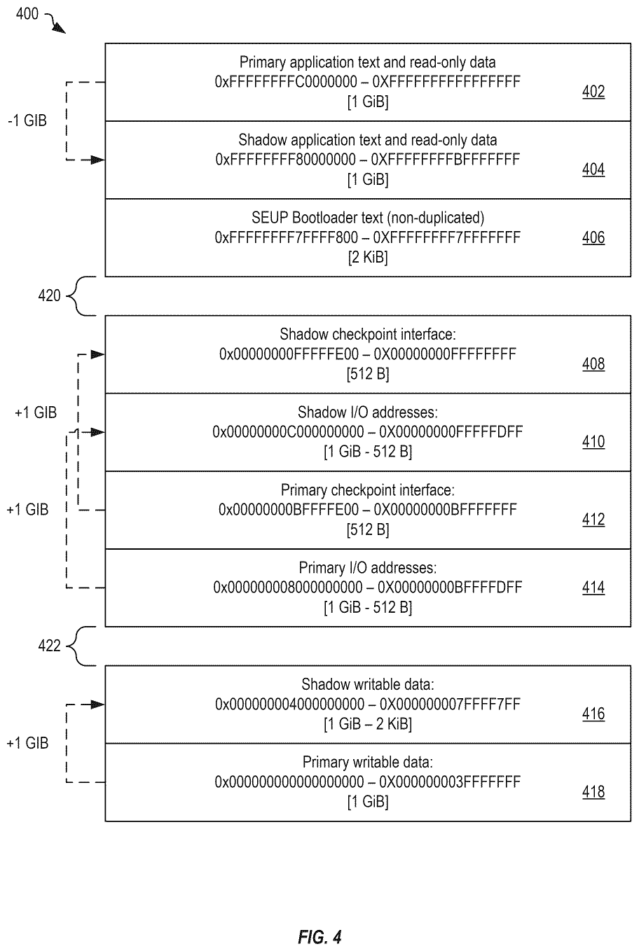

FIG. 4 is a block diagram illustrating one example address map 400 generated for SEUP solution 300 by SEUP transform tool 330 when unhardened processor 310 is a RISCV64 processor, in embodiments. In this example, primary application text and read-only data 402 refers to machine-readable instructions and constant data resulting from code 334(1) for use by primary core 312(1) and shadow application text and read-only data 404 refers to machine-readable instructions and constant data resulting from code 334(2) for use by shadow core 312(2). SEUP bootloader text 406 refers to executable instructions that configure SEUP 322 and implement rollbacks. A shadow checkpoint interface 408 represents addresses used by shadow thread 206 to communicate with SEUP 322. A shadow I/O addresses 410 represents addresses mapped to peripheral bus 324 for use by shadow thread 206. A primary checkpoint interface 412 represents addresses used by primary thread 204 to communicate with SEUP 322. A primary I/O addresses 414 represents addresses mapped to peripheral bus 324 for use by primary thread 204. A shadow writable data 416 represents addresses used by shadow thread 206 to access data memory 326. A primary writable data 418 represents addresses used by primary thread 204 to access data memory 326.

Address ranges of primary application text and read-only data 402, shadow application text and read-only data 404, SEUP bootloader text 406, primary I/O addresses 414, and primary writable data 418 are backed by memory or peripherals downstream of SEUP 322, while address ranges of shadow checkpoint interface 408, shadow I/O addresses 410, primary checkpoint interface 412, and shadow writable data 416 are not. Two address ranges 420 and 422 are unmapped portions of address map 400. The placement of primary application text and read-only data 402, shadow application text and read-only data 404, and SEUP bootloader text 406 at a top end of one example address map 400 and positioning of shadow checkpoint interface 408, shadow I/O addresses 410, primary checkpoint interface 412, primary I/O addresses 414, shadow writable data 416, and primary writable data 418 (e.g., mapped to data memory 326) at a bottom end of address map 400 (e.g., text and read-only data are at opposite ends of the 64-bit address space from I/O addresses and writable data) is due to restrictions on the addresses that may be encoded by relocations on the RISCV64 processor. For other processors, text and writable data may be positioned elsewhere within the address space without departing from the scope hereof.

As shown, primary application text and read-only data 402 and shadow application text and read-only data 404 are positioned at a relative offset of-1 GiB; primary checkpoint interface 412 and shadow checkpoint interface 408 are positioned at a relative offset of 1 GiB, and primary I/O addresses 414 and shadow I/O addresses 410 are positioned at a relative offset of 1 GiB. This 1 GiB offset is known as the SEUP offset and may be loaded into the SEUP offset register such that SEUP 322 may apply the SEUP offset when comparing writes.

Although the primary thread and the shadow thread use different physical addresses, SEUP 322 requires that pointer values written to memory or stored in registers at checkpoints for the primary thread and the shadow thread match exactly, to allow SEUP 322 to detect any corruption. To achieve this equivalence, SEUP transform tool 330 ensures that all addresses written to memory or stored in registers at a checkpoint are canonical, meaning that they point to the primary thread's data address range. When an address is accessed (e.g., used as the operand of a load, store, or indirect jump), the shadow thread converts the address by applying the SEUP offset immediately before the memory access and subsequently reverts the address immediately afterwards to return it to canonical form.

The act of converting between shadow thread address range to primary thread address range is known as swizzling. This is necessary to support code that treat pointers as data, such as jump tables or function pointers, without changes. Swizzling is applied to the following instruction types: Loads and stores: When the shadow thread accesses memory, it swizzles the address into the shadow thread address range, performs the access, then unswizzles the pointer back to the canonical state. Function entry/exit: The shadow thread unswizzles the shadow thread return address on function entry, to account for the possibility that it is stored to the stack, and swizzles it before returning. Indirect jumps: All indirect jumps initially load the canonical address of the destination, whether from memory or encoded as a relocation, and swizzles before jumping.

SEUP transform tool 330 generates the swizzling operations in shadow code 334(2) automatically for the instructions described above. In primary code 334(1), addresses do not need to be swizzled and SEUP transform tool 330 generates NOP instructions to match the swizzling operations inserted into the shadow thread to ensure instruction offsets are equivalent between the primary and shadow threads. That is, the added NOP instructions in primary thread 204 compensate for the swizzling operations added to shadow thread 206.

In the example of FIG. 4, SEUP solution 300 is built on physical addresses to support bare-metal deployments. However, SEUP solution 300 may support virtual addresses and operating systems without departing from the scope hereof.

### Logging and Verification

SEUP 322 functions as a REDO log for memory and I/O writes. When a write arrives at SEUP 322 (e.g., a cache line eviction), SEUP 322 buffers the write (e.g., storing address and data) pending verification. The data is not written to memory or to an I/O address until a checkpoint has been performed and a matching store from the sibling thread arrives at SEUP 322 (i.e., verification). This prevents potentially erroneous values from being written to memory or output to an I/O address by requiring execution equivalence between primary thread 204 and shadow thread 206 at each checkpoint.

When unhardened processor 310 includes write-back caches, dirty cache lines may not be evicted in the same order between the primary and secondary threads, and may remain in the caches for long periods. SEUP solution 300 supports processors with standard write-back caches, but requires that all dirty cache lines are written to memory (cleaned) before each checkpoint to ensure that both the primary and shadow threads exhibit the same memory signature.

To meet this requirement, cache-lines are cleaned explicitly by both primary and shadow threads using clean instructions. Cache clean instructions exists on all common processor architectures, including the ARMv8 and RISCV64 (with zicbom extensions) ISAs that are supported by SEUP solution 300. The clean instruction writes the contents of the dirty cache-line through all levels of cache to SEUP 322 without evicting the line from the cache.

As the clean instruction only needs to be issued between the actual store and a possible checkpoint, and is issued per cache line, significant batching may occur, especially on frequently accessed cache lines like the stack. A conservative solution to this problem is simply to issue a clean after every store, but optimization space exists. Temporally, when many stores target the same location, cache cleaning may be delayed until the last write. And spatially, batch cleaning may be used when many stores target different locations within the same cache-line.

SEUP solution 300 includes optimization. Due to limits of pointer analysis, stores not offset from the stack pointer are conservatively assumed to be unique and immediately cleaned. Stores offset from the stack pointer, with a known alignment, are tracked statically until the next possible checkpoint, then cleaned. This data analysis is done statically by SEUP transform tool 330 as described in more detail below.

Because the primary and shadow memories are equivalent at a checkpoint, their address spaces can overlap in memory—we keep only one copy of the data in rad-hard memory. On a load, SEUP 322 provides the most recently written value (possibly unverified) for that location from the associated address space, or, alternatively, fetches the value from memory.

### Checkpointing and Recovery

SEUP-protected programs periodically execute checkpoints. In the event of a failure, whether from a mismatch in the log, a hang, or architectural error (e.g. an illegal instruction), SEUP 322 causes a rollback to the most recent checkpoint. As checkpoints are expensive, they are only performed when necessary, namely, when the log of SEUP 322 is nearly full, before issuing an I/O, or under high error rates to ensure progress.

To determine when a checkpoint is needed, primary and shadow threads periodically execute a turnout, a small block of code inserted by SEUP transform tool 330 into each of primary code 334(1) and shadow code 334(2), which implements a “check for checkpoint. ” The turnout mechanism checks bits of the checkpoint register that are set by SEUP 322 to request a checkpoint based on its internal state (e.g., to when its log is nearly full).

Checkpoints may also be explicitly inserted by the programmer. The turnout uses an uncacheable read to a designated memory address mapped to the SEUP.

When a checkpoint is requested, each thread issues a fence to force any remaining cache line cleans to complete, writes the contents of its register file to SEUP 322, and concludes with a blocking write to a special register that provides barrier-like semantics: a completion notification is not returned for the write from the leading thread until the lagging thread performs a matching write.

Once the blocking write is notified, the checkpoint is complete from the perspective of unhardened processor 310, and each of the primary and shadow thread proceeds with execution. The period of execution between two checkpoints is called an epoch. While execution continues in unhardened processor 310, SEUP 322 verifies that the register set and dirty cache lines (e.g., logged writes) from each thread match, and SEUP 322 commits all logged writes to memory and/or to I/O for the epoch when correctly matched. When SEUP 322 detects a mismatch, SEUP 322 discards all writes for that epoch and resets unhardened processor 310, which reloads the register file from the most recent successfully completed epoch and resumes execution of primary and shadow threads at the start of the incomplete epoch. This is called a rollback and is different from a full-system reset.

It is anticipate that many SEUs will manifest as mismatches in memory writes or register contents, but it is also possible that a SEU causes unhardened processor 310 to hang, an architectural exception in unhardened processor 310, or an application error in one of cores 312 (e.g., an assertion failure). SEUP 322 uses a watchdog timer to detects hangs, and architectural exceptions and application errors are handled in software that explicitly requests SEUP 322 to cause a rollback. In both cases, recovery after reset is the same as described above.

### Seup Integration

SEUP 322 is placed between unhardened processor 310 and data memory 326.

When implemented as an external IC, the memory-mapped interface connecting SEUP 322 to unhardened processor 310 is required to support variable response latencies, precluding the use of standard DDRx. PCIe and CXL are the most widely supported interfaces that meet this requirement; less-common alternatives include DDR-T and RapidIO. When implemented on an rad-hard FPGA, SEUP 322 may be implemented using a Xilinx FIFO.

Alternatively, a specialized SEUP memory controller may be implemented on an I/O chiplet, hardened by design, and integrated with an otherwise unmodified processor. This takes advantage of chiplet-based architectures where the memory interface is frequently implemented on a different chiplet for cost and because I/O interfaces do not scale as effectively with process node shrinks. In either the external IC or chiplet scenario, the interface does not need to be radiation hardened since faults on this interface (hangs or corrupted data) are detected by SEUP 322.

### Concurrency Support

Although SEUP solution 300 is not illustrated interrupt-based concurrency or true multithreading, SEUP solution 300 may be expanded to support them. Interrupt support may be implemented by extending SEUP 322 to act as an interrupt controller, and delaying servicing of interrupts until threads quiesce at a turnout. At the turnout, when an interrupt is pending, SEUP 322 instructs both threads to execute replicated copies of the interrupt service routine (ISR).

Multi-threaded execution is difficult due to reliance of SEUP 322 on deterministic execution, but this is a well-studied problem. Existing solutions based on hardware logs have minimal performance overhead, and are well-suited as an extension of the existing logging functionality of SEUP 322.

### Software Implementation

SEUP transform tool 330 is built on top of gcc and musl libc. Program 332 is first compiled into assembly using gcc with two registers reserved for use by SEUP transform tool 330. The assembly is then converted into SEUP-compatible assembly by SEUP transform tool 330. This transformed code is assembled and linked into a custom ELF layout that holds the various segments for a SEUP application's memory, and loaded by a SEUP bootloader to run on bare metal. Where C standard library functionality (e.g. malloc etc.) is required, a version of musl libc, modified to remove dependencies on OS functionality not available in hardware portion 304 (e.g., computing platform 102), is linked.

### Turnout Placement Algorithm

As described above, primary and shadow threads each periodically read from a SEUP-controlled register to determine whether a checkpoint is needed. This read is implemented in turnouts that each divide execution into a set of runtime turnout regions. An epoch, the code between checkpoints, may include several turnout regions. SEUP transform tool 330 inserts turnouts such that there is a maximum number, called the clean threshold, of cache-line cleans occurs within any one turnout region. Enforcing this predefined clean threshold ensures the SEUP log within SEUP 322 does not overflow. Turnout placement is a static data-flow analysis problem, but no existing solution directly applies to turnout placement.

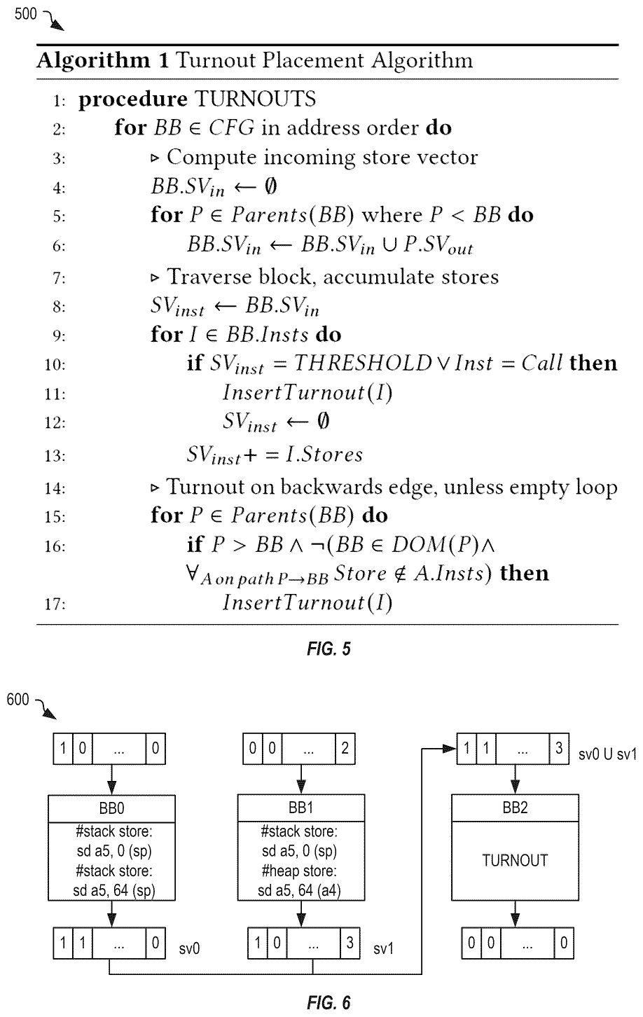

FIG. 5 shows one example turnout placement algorithm 500 for placing turnout code within codes 334 of FIG. 3, in embodiments. FIG. 6 is a block diagram illustrating one example StoreVector (SV) 600 used by turnout placement algorithm 500 of FIG. 5, in embodiments. FIGS. 5 and 6 are best viewed together with the following description.

Turnout placement algorithm 500 is shown in pseudocode and may be implemented in any suitable computer coding language. Turnout placement algorithm 500 is invoked by SEUP transform tool 330 and uses techniques from checkpoint-based region forming that are enhanced for determining placement of turnouts.

Turnout placement algorithm 500 processes a per-function control flow graph (CFG) to determine turnout regions. A CFG is a directed graph that represents all paths that might be traversed through a program during its execution. Each node in the graph represents a basic block—a straight-line sequence of code with no branches (except at the end) and no entry points (except at the beginning). Each edge represents a possible flow of control from one block to another. The CFG may be generated by the compiler or by analysis performed by SEUP transform tool 330. Turnout placement algorithm 500 processes the CFG to determine where turnouts should be placed. On each edge of the CFG, the maximum number of dirty cache lines since the last turnout is tracked using a structure called a StoreVector (e.g., SV 600). The StoreVector includes a bitmap that tracks dirty stack cache lines, and a counter that tracks stores to unknown locations: the number of dirty cache lines is statically never more than a sum of the counter plus all set bits in the bitmap.

Each basic block in the CFG holds a single input and output StoreVector. The value of the input StoreVector is a “union” of all incoming vectors from parent blocks: the bitwise OR of the parent's dirty stack bits, combined with the max of each unknown cache-line counter. FIG. 6 shows the “union” operation of StoreVectors in which incoming StoreVectors from parents are merged into the child.

Turnout placement algorithm 500 traverses the CFG once, in instruction address order, to compute StoreVectors and insert turnouts. SEUP transform tool 330 then traverses the child's instructions, accumulating stores within the StoreVector and adding turnouts internally should the number of writes pass the clean threshold.

SEUP transform tool 330 enforces the invariant that later parents (in address order) cannot impact the child's incoming StoreVector. In a loop, a later parent would have a turnout placed before jumping backwards to the child. This turnout may be elided, however, when the child dominates the parent and no writes occur on any path between them (e.g., the loop is empty of stores and has a single entry).

This strategy is conservative, generally forming turnout regions far smaller than the clean threshold supported by SEUP 322. Since turnouts require an expensive uncacheable read from SEUP 322 that stalls the pipeline, the frequency of turnouts is further reduced by reserving a register, used by the turnout code, to count the number of stores since the last turnout, and only performing the uncacheable read from SEUP 322 when needed.

### Hardware Implementation

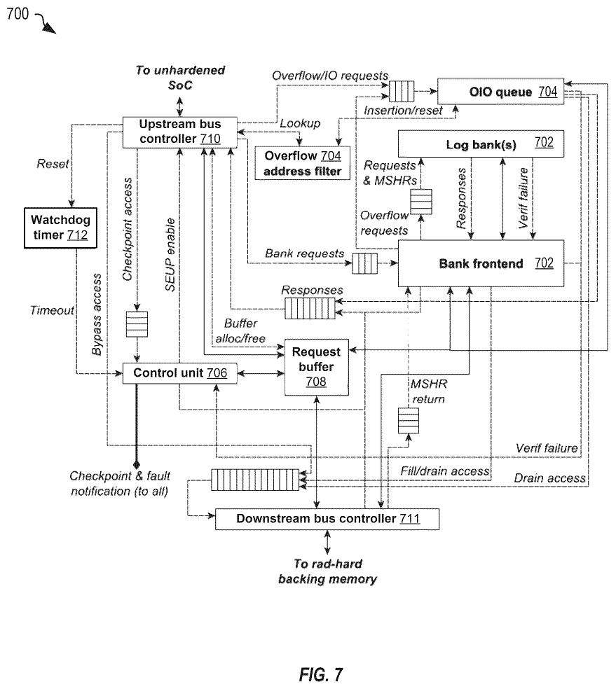

There is a wide design space for implementing the hardware interface of SEUP 322 as described above. In certain embodiments, design of SEUP 322 is based on a public reference design for a modern, highly parallel shared cache that is significantly modified to implement the needed error detection and correction (EDAC). FIG. 7 is a schematic illustrating one example hardware design 700 of SEUP 322 of FIG. 3, in embodiments. Hardware design 700 includes a main log 702 with associated front end, an overflow/Input/Output (OIO) queue 704 and associated Bloom filter, and a control unit 706. Hardware design 700 also includes storage 708 for in-progress requests, upstream bus connections 710, downstream bus controller 711, and a watchdog timer 712 that is reset each time an access is accepted by upstream bus controller 710. When watchdog timer 712 expires, a rollback is triggered since no activity from unhardened processor 310 is detected by upstream bus connections 710 for a predefined watchdog period, indicating a hang in unhardened processor 310 and/or architectural exception.

### Seup Log

A main log of SEUP 322, implemented within storage 708, functions as a set-associative cache that does not evict dirty entries until a checkpoint is performed and the entries are checked for errors. The log is divided into banks, each mapped to an interleaved range of the address space, which handles one access to their component sets at a time. Each logical block in the log corresponds to one block in data memory 326, but contains three equal-sized copies: one for the primary thread's working copy, one for the shadow thread's, and one to save verified data without writing to memory. Data for in-progress evictions and fills is buffered in miss status holding registers (MSHRs), as in conventional caches.

When a checkpoint is performed, each block written since the last checkpoint is verified by checking whether the primary and shadow copies match. Once a block is verified, it is not evicted immediately, but instead marked as both verified and dirty. The block is only evicted from the log when its set is full and it is selected for replacement. Only blocks that are clean (e.g., the block matches contents of data memory 326), or that are from a fully verified epoch may be replaced. When an access needs to allocate a block and no blocks in the matching set may be replaced, the access data is sent instead to an IO/overflow queue.

### Overflow/IO Queue

OIO queue 704 implements a FIFO log that SEUP 322 uses for I/O accesses and overflow accesses (see above). The storing of I/O accesses in OIO queue 704 may have external side effects. Each entry in OIO queue 704 consists of two blocks corresponding to primary and shadow data copies. After a checkpoint is completed, cached writes from the corresponding epoch are verified and drained to downstream bus controller 711 in chronological order (unlike entries in storage 708, which may remain undrained indefinitely after being verified).

There are distinct reasons for directing overflow and I/O accesses to OIO queue 704. Overflow accesses are redirected to allow the use of a larger clean bound that is used by SEUP transform tool 330 for forming turnout regions, which improves performance of unhardened processor 310. Without the overflow queue, the clean bound is limited by the associativity of the bank sets, which has an exponential area cost to increase. I/O accesses are sent to OIO queue 704 to maintain ordering and separation of I/O writes to external devices, since they may have side effects which would be affected by coalescing in the main log.

### Control Unit

Control unit 706 is responsible coordinating epoch transitions and rollbacks across unhardened processor 310, and implementing semantics for turnout reads and checkpoint writes. As described above, turnouts allow SEUP 322 to request checkpoints. SEUP 322 requests a checkpoint for two reasons. First, when a set in the log becomes full (e.g., when a count of writes to SEUP 322 reaches a write threshold), SEUP 322 requests a checkpoint so that the set is verified and replaced (if necessary). Second, when SEUP 322 performs a rollback due to a detected error, it sets a low write threshold (e.g., 8) such that fewer writes cause a next checkpoint. When this write threshold is reached, SEUP 322 requests a checkpoint. After each checkpoint, the write threshold is doubled until it reaches a large maximum value (e.g., 64K), thereby increasing the size of the epoch. This ratchet mechanism ensures application progress under frequent rollbacks (e.g., when errors are frequent in a high-radiation environment).

Control unit 706 may receive a fault signal due to expiration of watchdog timer 712, a block mismatch in OIO queue 704 or storage 708, or a register mismatch within control unit 706 itself. When control unit 706 determines a fault, it signals OIO queue 704 and log banks (e.g., storage 708) to discard writes from unverified epochs. Control unit 706 then drives a reset to unhardened processor 310. The bootloader reloads the registers from the SEUP, and then jumps to the point where execution resumes via a software trampoline (e.g., a known method of restarting the threads on each core 312).

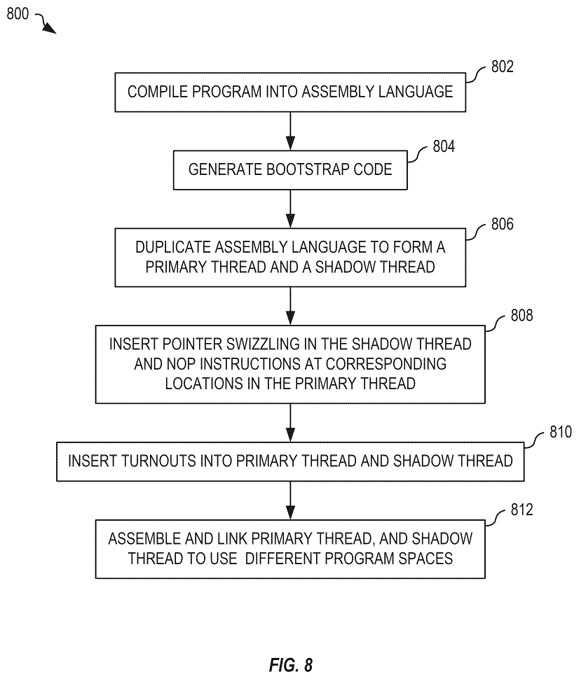

FIG. 8 is a flowchart illustrating one example method 800 for implementing SEUP solution 300, in embodiment. Method 800 is implemented by SEUP transform tool 330 of FIG. 3 for example.

In block 802, method 800 compiles a program into assembly language. In one example of block 802, program 332 is compiled into assembly language and input to SEUP transform tool 330. In block 804. method 800 generates bootstrap code. In one example of block 804, SEUP bootloader text 406 is generated. In block 806, method 800 duplicates assembly language to form a primary thread and a shadow thread. In one example of block 806, SEUP transform tool 330 generates primary code 334(1) and shadow code 334(2).

In block 808, method 800 inserts pointer swizzling in the shadow thread and NOP instructions at corresponding locations in the primary thread. In block 810, method 800 inserts turnouts into the primary thread and the shadow thread. In one example of block 810, SEUP transform tool 330 uses turnout placement algorithm 500 to insert a small block of code that checks for a checkpoint. In block 812, method 800 assembles and links the primary thread and the shadow thread to use different program spaces. In one example of block 812, codes 334(1) and 334(2) are assembled and linked into a custom ELF layout and stored in instruction memory 320.

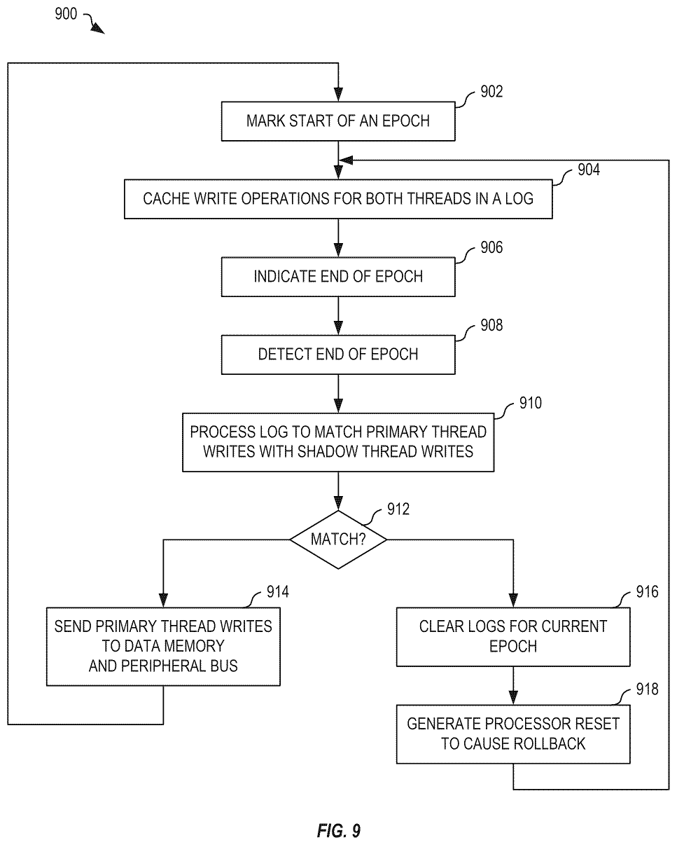

FIG. 9 is a flowchart illustrating one example method 900 for soft error protection for unhardened processors, in embodiments. Method 900 is implemented by SEUP 322 of FIG. 3 for example.

In block 902, method 900 mark start of epoch. In one example of block 902, each of primary thread and shadow thread stores a copy of their registers at SEUP 322 and SEUP 322 stores this information as checkpoint data in preparation for a rollback when needed. In block 904, method 900 caches write operations for both threads in a log. In one example of block 904, SEUP 322 intercepts writes from primary thread 204 and secondary thread 206 and logs the writes in main log 702 and OIO queue 704.

In block 906, method 900 indicates an end of the epoch. In one example of block 906, when main log 702 and/or OIO queue 704 are nearly full, SEUP 322 sets a checkpoint register to indicate a checkpoint is required. In block 908, method 900 detects an end of the epoch. In one example of block 908, SEUP 322 detects the end of the epoch when each thread forces any remaining cache line cleans to complete, writes the contents of its register file to SEUP 322, and when both threads have performed a blocking write to a special register of SEUP 322.

In block 910, method 900 processes the log to match primary thread writes with shadow thread writes. In one example of block 910, control unit 706 processes main log 702 and OIO queue 704 to match writes of primary thread 204 and secondary thread 206.

Block 912 is a decision. If, in block 912, method 900 determines that all writes are matched, then method 900 continues with block 914; otherwise, method 900 continues with block 916. In block 914, method 900 sends primary thread writes to the data memory and the peripheral bus. In one example of block 914, SEUP 322 sends cached writes from OIO queue 704 to peripheral bus 324 and cached writes from main log 702 to data memory 326. Method 900 then continues with block 902 to start a next epoch.

In block 916, method 900 clears logs for current epoch. In one example of block 916, control unit 706 clears writes stored in main log 702 and OIO queue 704 for the current epoch. In block 918, method 900 generates a processor reset to cause a rollback. In one example of block 918, control unit 706 activates reset 222 of unhardened processor 108 to cause the SEUP bootloader to restart each of primary thread 204 and shadow thread 206 to repeat processing of the current epoch. Method 900 continues with block 904 to repeat the current epoch.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for soft error protection of an unhardened processor, comprising:
receiving assembly code corresponding to a program;
generating a primary thread and a shadow thread, each operating in different address spaces of the unhardened processor;
inserting swizzling operations in the shadow thread to maintain canonical pointer values; and
inserting a Single Event Upset Protector (SEUP) between the unhardened processor and (a) a data memory and (b) a peripheral bus, the SEUP caching, for both the primary thread and the shadow thread, memory writes to the data memory and I/O writes to the peripheral bus;
wherein the SEUP restarts the primary thread and the shadow thread at a previous checkpoint when the thus cached memory writes and the thus cached I/O writes by the primary thread do not match the thus cached memory writes and the thus cached I/O writes by the shadow thread.

2. The method of claim 1, further comprising inserting clean instructions into both the primary and shadow threads to flush dirty cache lines to the SEUP prior to a next checkpoint.

3. The method of claim 2, wherein the inserting of the clean instructions is optimized by one of (i) inserting the clean instructions after a last store to a cache line, or (ii) batching multiple stores within a same cache line.

4. The method of claim 1, wherein the swizzling operations include converting memory addresses in the shadow thread to a shadow thread address range before access and reverting them to a canonical form after the access.

5. The method of claim 1, further comprising inserting NOP instructions into the primary thread to compensate for the swizzling operations added to the shadow thread.

6. The method of claim 1, further comprising inserting turnout instructions into both the primary thread and the shadow thread to periodically check a checkpoint register of the SEUP for checkpoint requests, wherein the turnout instructions are placed using a static data-flow analysis algorithm that limits a number of cache-line cleans per turnout region to a predefined clean threshold.

7. The method of claim 6, wherein a frequency of turnouts is reduced by reserving a register that counts a number of stores since a last turnout, and only performing an uncacheable read from the SEUP when the number of stores indicates the turnout is needed.

8. The method of claim 1, wherein the primary thread and the shadow thread are configured to execute in spatially disjoint address spaces to eliminate cache coherence conflicts.

9. The method of claim 1, further comprising reserving at least one register of the unhardened processor for storing a SEUP offset and checkpoint signals.

10. The method of claim 1, wherein, for the primary thread, the SEUP outputs the cached memory writes to the data memory and outputs the cached I/O writes to the peripheral bus when the thus cached memory writes and the thus cached I/O writes by the primary thread match the thus cached memory writes and the thus cached I/O writes by the shadow thread.

11. The method of claim 10, wherein the SEUP maintains temporal order of the cached I/O writes output to the peripheral bus.

12. A system for protecting an unhardened processor from soft errors, comprising:
a Single Event Upset Protector (SEUP) transform tool, implemented as software with machine-readable instructions executable by a processor, for causing the processor to transform a program into a primary thread and a shadow thread that operate in different address spaces and run concurrently on different cores of the unhardened processor;
a SEUP positioned between the unhardened processor and (a) a data memory and (b) a peripheral bus, the SEUP having:
a control unit;
an upstream bus controller for interfacing with the unhardened processor;
a downstream bus controller for interfacing with the data memory; and
a log for caching memory writes to the data memory for both the primary thread and the shadow thread; and
an Overflow/Input/Output (OIO) queue for caching I/O writes to the peripheral bus for both the primary thread and the shadow thread;
wherein, at an end of a checkpoint period, the control unit is adapted to trigger a rollback of the unhardened processor when the thus cached memory writes in the log and the thus cached I/O writes in the OIO queue for the primary thread do not match the thus cached memory writes in the log and the thus cached I/O writes in the OIO queue for the shadow thread.

13. The system of claim 12, the log comprising a set-associative cache with separate entries for primary thread memory writes, shadow thread memory writes, and matched memory writes, and does not evict dirty entries until verification.

14. The system of claim 12, the OIO queue configured to store unmatched memory writes when the log is full or when I/O operations are performed, and to drain matched I/O writes in order after a checkpoint.

15. The system of claim 12, the control unit being configured to coordinate checkpoint periods, the rollback, and fault detection based on mismatches, hangs, or architectural exceptions.

16. The system of claim 15, the control unit comprising a watchdog timer for triggering the rollback when no activity is detected from the unhardened processor for a predefined watchdog period.

17. The system of claim 12, the SEUP being configured to support externally synchronous I/O writes by committing I/O data only after verification at a checkpoint, to support bare-metal deployment, and to interface with the unhardened processor via a memory-mapped interface supporting variable response latencies.

18. The system of claim 12, the SEUP being implemented as one of: (a) an external integrated circuit, (b) a radiation-hardened FPGA, or (c) a hardened I/O chiplet integrated with the unhardened processor.

19. The system of claim 12, the SEUP adapted to support deterministic execution of redundant threads and to enable rollback by restoring a state of the unhardened processor from a most recently verified checkpoint.

20. The system of claim 12, the control unit adapted to (i) reduce the checkpoint period when the thus cached writes in the log and the OIO queue for the primary thread do not match the thus cached writes in the log and the OIO queue for the shadow thread, and (ii) to increase the checkpoint period when the thus cached writes in the log and the OIO queue for the primary thread match the thus cached writes in the log and the OIO queue for the shadow thread.
